(19) United States
(12) Patent Application Publication
(10) Pub. No.: US 2012/0120027 A1
(43) Pub. Date: May 17, 2012

(54) METHOD AND DEVICE FOR CONTROLLING A DATA PROCESSING SYSTEM

(75) Inventor: Richard Ebner, Wels (AT)

(73) Assignee: isiIQirl Interface Technologies GmbH, Hagenberg (AT)

(21) Appl. No.: 13/264,705

(22) PCT Filed: Apr. 15, 2010
(86) PCT No.: PCT/AT2010/000110

§ 371 Date: Oct. 14, 2011

(30) Foreign Application Priority Data
Apr. 21, 2009 (AT) A 609/2009

(51) Int. Cl. G06F 3/042

(52) U.S. Cl. 345/175

(57) ABSTRACT

A method and a device for controlling a data processing system is provided. A light beam is emitted from a pointing device to a control surface which is equipped with one or more optical position detectors connected to the data processing system. The data processing system is influenced in accordance with the impact point of the light beam on the control surface. In order to be able to input different characters using the pointing device independently from where the light beam emitted by the pointing device is currently pointing, the light intensity emitted by the pointing device to the control surface oscillates in a pulse sequence characteristic for individual characters. The optical position detector is a flat luminescence optical wave guide with local photoelectric sensors enabling it to achieve the required high resolution. In a further embodiment, the identity of a pointing device is coded in the pulse sequence, enabling a clear distinction of several input devices.

EP 1 696 300 A1, for example, describes a so-called optical joystick. A pivotably mounted lever is provided, at one end, with a light source which, depending on the position of the lever, shines on a particular region of a surface provided with an array of light-sensitive cells. The electrical signals produced thereby on the cells are usually read in by a computer and are interpreted in such a manner that, from the point of view of the user, the joystick has the same effects on the computer as a joystick in which the position is taken from non-reactive resistors. A cursor symbol on the screen of the computer is typically moved with the joystick. Depending on which function is assigned to which location on the screen, a particular action can then be triggered by operating a switch or the Enter key if the cursor is situated there. The light-sensitive cells onto which light is shone from the lever of the cursor are not normally seen by the operator. With a corresponding design, a small area of light-sensitive cells is enough.

The documents DE 42 39 389 A1, EP 354 996 A2 and EP 225 625 A2 describe optical position measuring devices in which fluorescent molecules are arranged on or in a surface which effects optical waveguiding, which molecules convert externally impinging light into longer-wave, diffusely scattered light which is guided in the surface that effects optical waveguiding toward the surface edges thereof and is either already detected there in terms of its intensity by sensors or is only detected at a different location to which it is guided via optical waveguides. Since the intensity of the measured light decreases with the distance from the point of impingement of the light beam, the point of impingement of the light beam can be deduced by combining the measurement results from a plurality of sensors. The use of this principle for an input device of a data processing system is not envisaged in said documents. Moreover, the position resolution is not good enough for that purpose in the case of relatively large surfaces since the detectors are usually fitted at the edge of the waveguide in the present documents.

US 2007152985 A1 presents an optical touchpad in the form of a planar optical waveguide. An object which is in contact with the waveguide of the touchpad couples in light from an external source into the waveguide of the touchpad by means of scattering at the surface of the object. A photoelectric detector which is not described in greater detail makes it possible to detect the coupling-in location.

In accordance with WO 2007/063448 A2, the position of a luminous pointer with respect to a screen is determined using a plurality of photodiodes which are arranged beside the screen. In this case, the pointing beam is very widely fanned out and its light intensity decreases from its center. From the knowledge of the intensity distribution over the cross-sectional area of the light beam, the distance to the center of the cross section of the beam and thus to the point at which this center of the beam impinges on the display surface is calculated back after the intensity has been measured at the individual detectors. The positional accuracy which can be achieved is relatively limited, particularly when the location of the pointing device emitting the pointing beam changes.

US 2005/0103924 A1 describes a shooting training device using a computer. The target device sends an infrared laser beam with a cruciform cross-sectional area to a screen connected to a computer. The edge of the screen is surrounded by a number of photodiodes via which the computer detects the position of the cross-sectional area of the laser beam. As a “shot”, the laser beam is briefly switched off by the target device. The computer then displays the point of intersection of the bars of the cross-sectional area of the laser beam before this interruption on the screen.

The object on which the invention is based is to provide a control device for a data processing system, a light beam being sent to a control surface, and the data processing system being influenced on the basis of the location at which the light beam impinges on the control surface, for example by virtue of the point of impingement being assigned a cursor position in a menu or on a virtual typesheet or character sheet. The design to be provided is intended to make it possible to input a larger number of distinguishable commands to the data processing system than is possible with the currently known control devices of this type.

In order to achieve the object, it is assumed that a light beam is sent from a pointing device to a control surface which is provided with one or more optical position detectors which are connected to the data processing system, the data processing system being influenced on the basis of the location at which the light beam impinges on the control surface. The invention provides for:

the light intensity of the light beam emitted by the pointing device onto the control surface to fluctuate in predeterminable temporal pulse sequences which can be distinguished from one another,

the temporal fluctuations in the intensity of the light beam which represent pulse sequences to be detected by a position detector which is constructed as a flat luminescence optical waveguide and is provided with photoelectric sensors,

the data processing system to attribute meanings to the individual pulse sequences according to a stored assignment rule.

By virtue of the fact that the light intensity fluctuates over time in pulse sequences and meanings are attributed to these pulse sequences, a pointing device can inform the data processing system of different “characters”. For this purpose, the pointing device may have a plurality of different buttons. Pressing a button sends a light beam whose intensity fluctuates with a particular pulse sequence assigned only to this individual button. The data processing system detects this pulse sequence and assigns a “meaning” to the latter, for example the arrival of the input of a particular letter.

So that the entire system can be used in a convenient manner, the total duration of a pulse sequence may be only very short, for example 1 ms. So that such short pulse sequences can be clearly broken down into the individual pulses which then perhaps last for only 1 μs, there is a need for fast optical position detectors. Such position detectors can best be implemented by far by flat luminescence optical waveguides which are locally provided with photoelectric sensors for coupling light from the waveguide mode.

The invention is illustrated using sketch-like drawings.

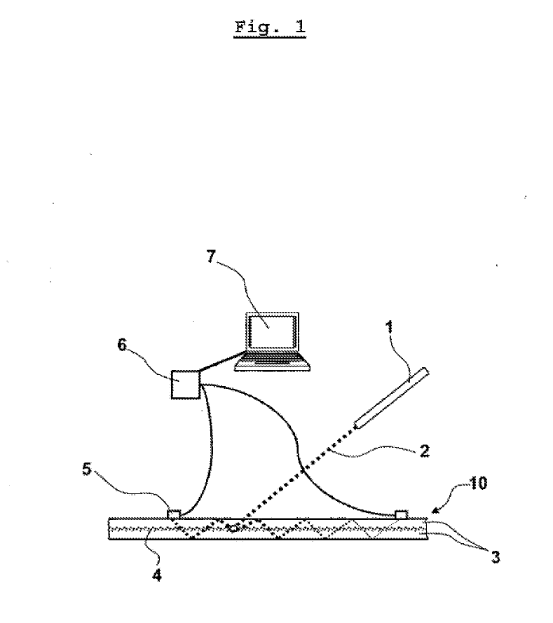

FIG. 1: symbolically shows those elements of an exemplary device according to the invention which are essential to the understanding of the invention. Light beams are symbolized by dotted lines.

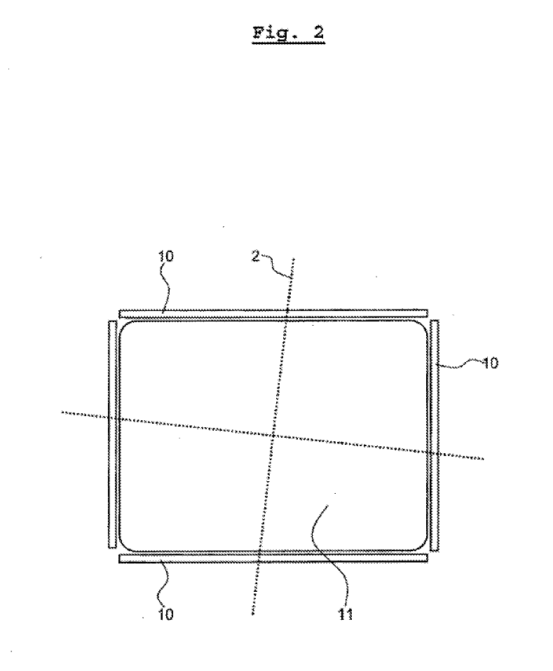

FIG. 2: shows a front view of an exemplary control surface formed from a display surface and position detectors. The cross-sectional area of a light beam is illustrated using dotted lines.

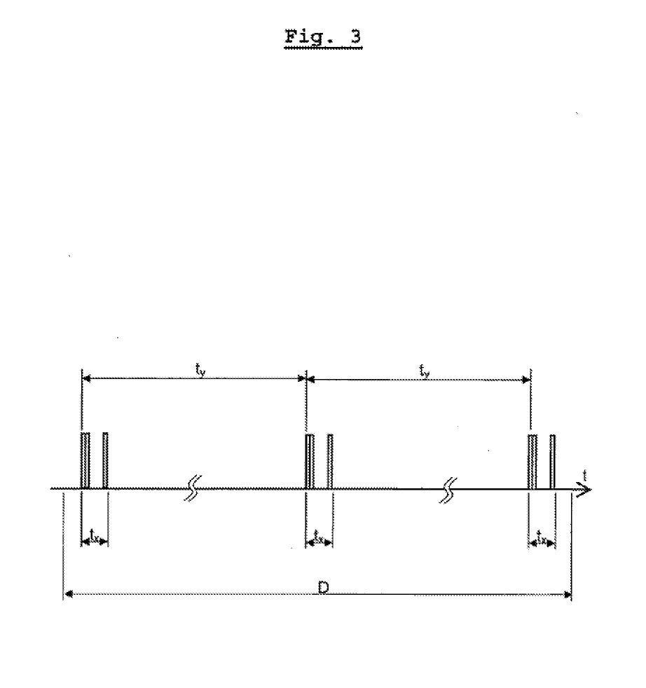

FIG. 3: shows an exemplary, idealized timing diagram for a possible intensity profile of a light beam emitted by a pointing device.

According to FIG. 1, a pointing device 1 sends a light beam 2 to a control surface on which an optical position detector 10 which is constructed from a plurality of layers 3, 4 and photoelectric sensors 5 for the electrical measurement signal generated. The measurement signal passes to the data processing system 7 via a frequency filter 6 (optional).

The optical position detector 10 consists, for example, of two PET covering layers 3 which have a thickness of approximately 0.1 mm and between which a layer 4 which has a thickness of approximately 0.001 mm and is made of a homogeneous mixture of the plastic polyvinyl alcohol and of the dye Rhodamine 6G is laminated. The PET layers 3 form, with the layer 4 in between, an optical waveguide. The layer 4 is photoluminescent. In a square grid with a period length of 5 cm, silicon photodiodes are fitted, as photoelectric sensors 5 which have a cross-sectional area of approximately 2×2 mm², to the exposed side of one of the two PET layers 3 in such a manner that they couple light from the PET layer and couple it in at their pn junction. The signals from all photoelectric sensors 5 are supplied, via electrical lines and a frequency filter 6, to a data processing system 7 in which they are measured and processed.

If a light beam 2 with an appropriate spectrum strikes the layer 4, it triggers luminescence in the integrated particles. The resultant longer-wave light is largely coupled into the waveguide formed by the layers 3 and 4. The light in the waveguide mode is attenuated by the distribution and attenuation in the waveguide. A different intensity of the light in the waveguide mode is thus measured at the photoelectric sensors 5 depending on how far away the point of impingement of the light 2 producing the luminescence is from the photoelectric sensor 5. The position of the point of impingement can be inferred by comparing the signals at the different sensors.

Depending on the area and required resolution, any desired number of photoelectric sensors can be mounted on the surface, preferably in a regular pattern. For the mounting process, it is possible to use an adhesive which cures in a transparent manner for the emission of the dye and establishes good optical contact between the waveguide and the photoelectric sensor 5. The more densely the sensors are mounted, the greater the signal and accordingly the resolution of the component with the same read-out electronics. In experiments with an optimized waveguide based on a plastic plate doped with dyes, it was possible to obtain an accuracy of better than +/−1 mm when the sensors are spaced apart by 12 cm in a square pattern.

The described design, based on luminescence waveguiding, for a position detector which can be formed as a surface can achieve a very high temporal resolution of the measurement result.

It would also be possible to produce optical position detectors on a large scale in a cost-effective manner on the basis of a layer of an organic photosemiconductor. However, this could scarcely achieve the required temporal resolution.

An optical position detector 10 according to the invention may be implemented, for example, as a layer on a projection screen which is used as a display surface for a data processing system.

As sketched in FIG. 2, optical position detectors 10 can also be fitted at the edges of a display surface 11 for a data processing system in the form of narrow strips. For this purpose, the position detectors 10 are able to detect the position of a point of light impinging on them with respect to their longitudinal direction. A cross-sectional view of the light beam 2 from the pointing device is visible in FIG. 2. This cross-sectional view is formed by two lines which are perpendicular to one another and cross one another. The position of the points of intersection of these lines on the individual position detectors 10 is forwarded from the individual position detectors to the data processing system to be controlled. The data processing system can calculate the position of the point of intersection of the two cross-sectional lines of the pointing beam 3 on the display surface as the point of intersection of those two straight lines which respectively connect the two points of intersection 10 on two position detectors which are oriented in the same manner. The position of a cursor, that is to say an insertion mark, a writing mark or an input marker which is otherwise usually moved using a “mouse”, on the display surface can be assigned to these coordinates by the operating system running on the data processing system.

Only the coordinates of the point of impingement on the position detectors in their longitudinal direction, rather than the light intensity of that part of the pointing beam which impinges on the individual position detectors, are important for determining the position of the pointing beam. The measurement accuracy thus becomes independent of the distance of the pointing device emitting the pointing beam in a wide range.

During the interval of time tₓ according to FIG. 3, a pointing device emits a light beam whose intensity pulses with the temporal profile illustrated in the interval of time tₓ in FIG. 3. This pulsing can be understood as binary coding of a character which is sent by the pointing device to the control surface so that it is forwarded from the position detector arranged there to the data processing system as a character which has been input. The duration of the interval of time tₓ may typically be 10 μs. This signal is repeated at regular intervals of time t_{y} which are considerably longer than tₓ. The data processing system now measures within an interval of time D which is longer than twice t_{y}, with the result that the data processing system always receives at least two pulse sequences of the duration tₓ within one measuring interval.

If the start or end of the interval t_{y} is defined by a signal from the pointing device, an item of information can be assigned to the position of a shorter sub-interval of time tₓ in the longer interval t_{y}. If only one pointing device is used, an abundance of different characters can thus be coded in a simple manner by virtue of the pointing device respectively sending only a short pulse at that point in time inside the interval t_{y} which was precisely defined as being characteristic of the character to be sent.

If a plurality of pointing devices are intended to be able to be used and are intended to be able to be distinguished by the data processing system, each individual pointing device may have an individual interval of time t_{y}, t_{y} always being shorter than half the duration of the interval D. The start or end of t_{y} then does not need to be characterized by a separate signal. The data processing system can thus discern, from the time t_{y} in which the same pulse sequences—an individual one of which lasts for a maximum of tₓ—are repeated, which pointing device has sent these pulse sequences. The number of pointing devices is mainly limited by the fact that the pulse sequences must not overlap at any time during tₓ. However, this is only so rarely the case with very fast signals and few pointing devices (for example four) that these errors can be ignored.

The coding of characters by pointing devices can be carried out independently of the point of the control surface to which the light beam from the pointing device points. The possibility of calculating back the position remains unaffected in this case. The interval of time D may typically last for 200 μs.

A plurality of pointing devices with a plurality of functionalities can therefore be connected to an interactive screen without the need for a data connection between the elements, apart from the light beam.

Particularly in order to prevent interference from ambient light, it is expedient to allow the intensity of the light beam emitted by the pointing device to fluctuate in a frequency-modulated manner and to filter the measurement result from a position detector according to this modulation frequency. For this purpose, the modulation frequency must be considerably higher than the frequency at which the binary coding of characters is effected by means of pulses of the light intensity.

Another method for suppressing the background signal caused by ambient light is an upstream frequency filter which filters all low-frequency signals from the detector signal but transmits the pulses having a very high frequency. This can be achieved either using simple software solutions (for example by forming the second mathematical derivative) or using corresponding electronic circuits.

The method according to the invention and the device according to the invention make it possible to make a wide variety of inputs using a pointing device without a direct data connection to a data processing system, which is not possible with previous methods. Furthermore, this enables the use of a plurality of input devices at the same time which can be detected and identified independently of one another. This enables a very convenient application since no data connection has to be installed using cables or radio.

1. A method for controlling a data processing system, a light beam being sent from a pointing device to a control surface which is provided with one or more optical position detectors which are connected to the data processing system, and the data processing system being influenced on the basis of the location at which the light beam impinges on the control surface, wherein
the light intensity of the light beam emitted by the pointing device onto the control surface fluctuates in predeterminable temporal pulse sequences which can be distinguished from one another,
the temporal fluctuations in the intensity of the light beam which represent pulse sequences are detected by a position detector which is constructed as a flat luminescence optical waveguide and is provided with photoelectric sensors,
the data processing system attributes particular meanings to the individual pulse sequences according to a stored assignment rule.

2. The method as claimed in claim 1, wherein the intensity of the light beam emitted by the pointing device fluctuates in a frequency-modulated manner, in that the measurement result from a position detector is filtered by a frequency filter whose passband is set to this modulation frequency, and in that the modulation frequency is many times higher than the reciprocal of the minimum duration of an individual pulse in such a pulse sequence which is attributed a meaning by the data processing system.

3. The method as claimed in claim 1, wherein signal components which have a lower frequency than the pulse sequences of the light beam emitted by the pointing device are filtered from the measurement result from a position detector.

4. The method as claimed in claim 1, wherein
a plurality of pointing devices are used, the individual pointing devices having individual intervals of time t_{y} at which they repeat pulse sequences which signify a character,
t_{y} being, at most, half the duration of such an interval of time D within which the data processing system reads in the profile of the measurement result from the position detection,
and in that the data processing system infers the pointing devices which transmit these pulse sequences from the times t_{y} in which the same pulse sequences are repeated.

5. A control device for a data processing system, a light beam being sent from a pointing device to a control surface which is provided with one or more optical position detectors which are connected to the data processing system, and the data processing system being influenced on the basis of the location at which the light beam impinges on the control surface, wherein
an optical position detector is constructed as a flat optical waveguide to which photoelectric sensors are fitted, with the result that light can be coupled from the waveguide into the photoelectric sensors,
in that the pointing device is suitable for emitting a light beam whose light intensity fluctuates in a predeterminable manner in different temporal pulse sequences which can be distinguished from one another, and
in that the data processing system stores an assignment rule which can be used to assign individual characters to individual pulse sequences measured by the position detectors.

6. The control device as claimed in claim 5, wherein the control surface extends over a display surface for the data processing system.

7. The control device as claimed in claim 6, wherein the position detectors are arranged on the display surface.

8. The control device as claimed in claim 6, wherein the position detectors are arranged along the edge of the display surface, in that the cross-sectional shape of the light beam which can be emitted by a pointing device is formed by a plurality of lines, and in that the cross-sectional dimensions of this light beam project both beyond the display surface and beyond the position detectors arranged on the latter.
